(19) United States
(12) Patent Application Publication
(10) Pub. No.: US 2011/0110074 A1
(43) Pub. Date: May 12, 2011

(54) GLOVELIGHT, AKA SUPERLIGHT - SUPERSPOT

(76) Inventor: Melinda Marie Cameron, Nampa, ID (US)

(21) Appl. No.: 12/992,086

(22) PCT Filed: May 12, 2009
(86) PCT No.: PCT/US09/43680

§ 371 Date: Nov. 11, 2010

Related U.S. Application Data
(60) Provisional application No. 61/071,803, filed on May 19, 2008.

(51) Int. Cl. F21V 21/08; A41D 19/00

(52) U.S. Cl. 362/103; 2/160; 2/167

(57) ABSTRACT

The Glovelight, aka Superlight-Superspot is a portable hands-free, multi-directional flashlight affixed to a spandex, Lycra, fingerless glove/stretchable band utilizing LED technology to produce a bright, efficient light source that renders both hands empty for performing any task.

### CROSS-REFERENCE TO RELATED APPLICATIONS

This application claims priority to U.S. Provisional Application No. 61/071,803, entitled “Glovelight” and filed on May 19, 2008, the disclosure of which is hereby incorporated in its entirety by reference herein.

### BACKGROUND OF THE INVENTION

The Glovelight, aka Superlight-Superspot is a portable hands-free, multi-directional flashlight.

### Field of the Invention

Positioning a flashlight just right, so one can see exactly where they are looking: under the hood of a car, in a dark closet, or even in the event of a power failure, is problematic; either one hand is always occupied, or once the flashlight is set down its beam aims only in one direction. Headlamps are helpful, but directing the beam is again problematic. Turning ones head toward the hands to watch what one is doing, or the feet to see where one is walking is difficult. As a result, performing tasks in the dark for a number of reasons has proven difficult and frustrating.

### BRIEF SUMMARY OF THE INVENTION

To overcome these obstacles the Glovelight, aka Superlight-Superspot allows for bright, direct, illumination of the subject that is desired to be in the field of view of the operator, while simultaneously leaving the hands unencumbered as to allow for the operation of anything from a pair of tweezers to a shovel.

### BRIEF DESCRIPTION OF THE DRAWINGS

FIG. 1 illustrates the top view of unit riding on the back of a fingerless glove,

FIG. 2 illustrates the perspective view of unit riding on back of a fingerless glove,

FIG. 3 illustrates the front view of unit riding on back of a fingerless glove,

FIG. 4 illustrates the side view of unit riding on back of a fingerless glove,

FIG. 5 illustrates bottom view of unit attached to a stretchable band emphasizing recessed center,

FIG. 6 illustrates a cut-away view of unit attached to a stretchable band,

FIG. 7 illustrates the front view of unit attached to a stretchable band substituting halogen bulb,

FIG. 8 shows bottom view of unit attached to a stretchable band, left/right hand accommodation,

FIG. 9 illustrates a side view cut-away of unit attached to a stretchable band

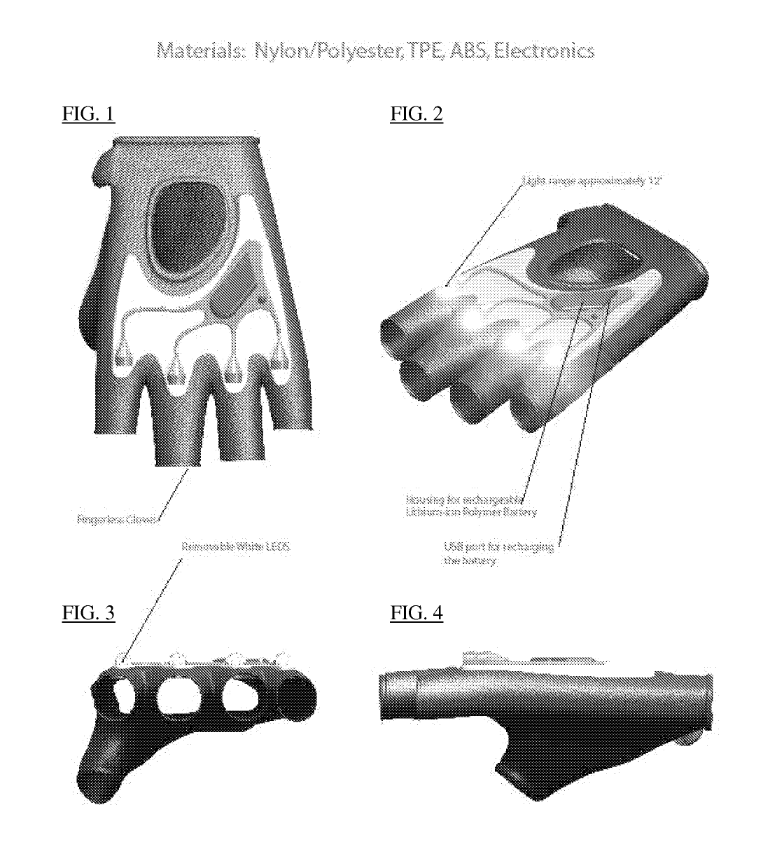

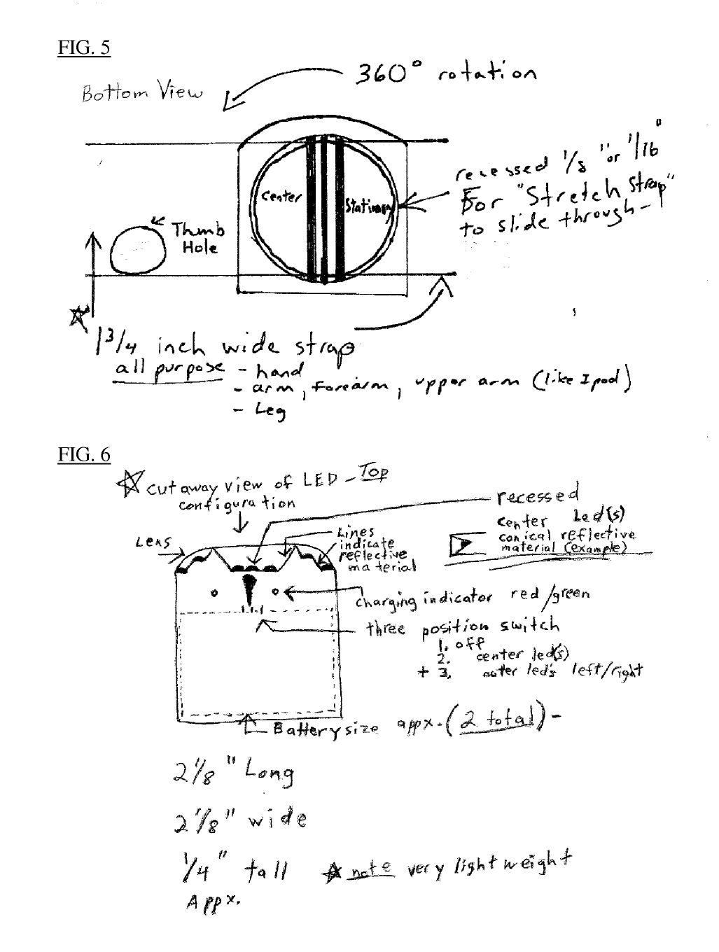

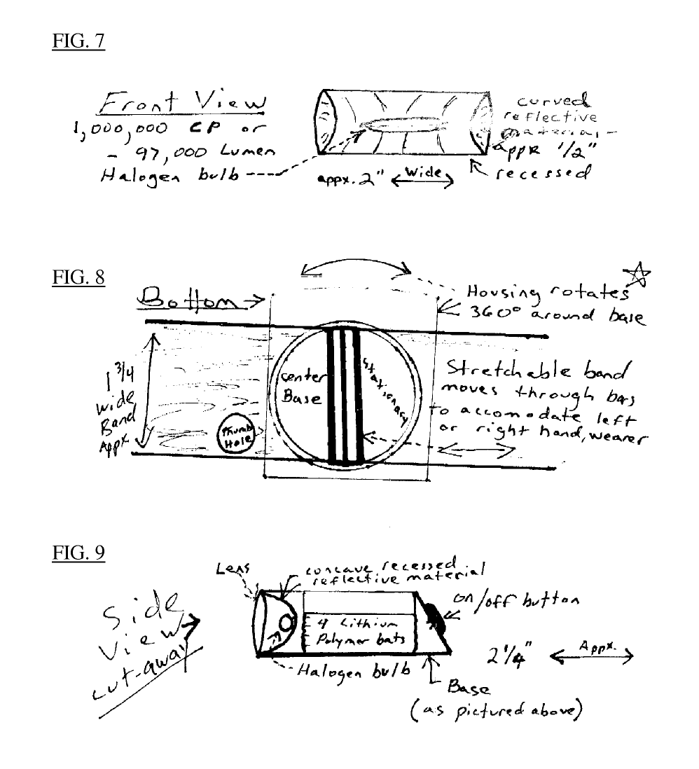

### DETAILED DESCRIPTION OF THE INVENTION

To achieve hands-free operation with optimal lighting the Glovelight, aka Superlight-Superspot is the solution. The Glovelight, aka Superlight-Superspot is a variable light source affixed on a fingerless glove/stretchable band riding on the back of the hand, fore arm, upper arm, left, right, or both. The housing of the Glovelight, aka Superlight-Superspot is affixed to a base that allows it to rotate 360 degrees, which the glove/band is threaded through and adjusts for either hand. This configuration allows the wearer to place the LED or halogen bulb, depending on the desired brightness, wherever they desire and direct the light in whichever direction is needed for each application. They are housed within a high impact plastic casing, which rides comfortably on the hand, fore arm, or upper arm to project light exactly where and how the operator/wearer desires. The glove itself is a Lycra, spandex, padded glove well suited for gripping yet snug enough to keep the light firmly in place. The size and shape of the Glovelight, aka Superlight-Superspot itself is no wider than the average hand, extends no further than the knuckles, and stops at the bend of the wrist to allow for complete free-hand movement. It extends a quarter of an inch in height using a combination of rechargeable Li-polymer batteries as a power supply allowing the Glovelight, aka Superlight-Superspot to be efficient, lightweight, and durable.

Mechanics, fire, military, police, search and rescue, and civilians performing tasks in the dark will no longer be presented with the typical and commonly accepted obstacles and difficulties as previously endured. Professionals or vacationers will now be able to have both hands free to work, repair, search, or even walk a dog at night in safety. Every application, whether it be looking at an object up close, or scanning an area at a distance will be easier and possible while utilizing the appropriate light source and direction of beam. Carrying a Glovelight, aka Superlight-Superspot in the trunk of the car, or putting one on a child's hand for night activities will provide safety and security.

What is claimed is:

1. A Glovelight, aka Superlight-Superspot comprising: multiple LED's and/or halogen bulb, high impact plastic housing affixed to a rotatable base or static fingerless, or fingered glove, (or the like) /stretchable band of lycra, spandex, or other snuggly fitting material (or the like), with on/off switch and/or multiple position switch, powered by Li-polymer rechargeable batteries. All this to provide an environment suitable for the Glovelight, aka Superlight-Superspot to be firmly attached and ride securely on the back of the hand, left, right, or both, wrist, fore arm, or upper arm.

2. A Glovelight, aka Superlight-Superspot as in claim 1, wherein light is projected from the hand, wrist, fore arm, or upper arm utilizing an internal, self contained power source, wherein the power supply is of a weight and size appropriate for the ergonomics of freehand movement, and meets the load required to produce a sufficient and efficient light source (either rechargeable, replaceable, disposable, or solar).—Or the Glovelight, aka Superlight-Superspot is attached to an external power source (outside of its own casing/housing) located on any other part of the body, uniform, suit, or combination, or variation thereof using any type of battery or power supply necessary or possible for the intended application; any power supply that can be, is intended to be, or is used to power the Glovelight, aka Superlight-Superspot is to be considered a unit with said Glovelight, aka Superlight-Superspot.

3. A Glovelight, aka Superlight-Superspot as in claim 2, wherein the case/housing is designed specifically to ride on the back of the wearer/operator's hand, (left hand, right hand, or both hands), wrist, fore arm, or upper arm, whether attached to a glove, strap, velcro, or any other type of attachment allowing it to ride on the back of the hand, wrist, fore arm, or upper arm, the case being comprised of high impact plastic, aluminum, or any other alloy, or type of material.

4. A Glovelight, aka Superlight-Superspot as in claim 3, wherein light is projected from a light source which is attached to and rides on the back of the hand, fore arm, or upper arm from any light source type, standard bulb, LED, halogen bulb, laser, or variation, (or the like), plain white, or multi-colored, or any variation thereof, including all colors, and/or number of bulbs, LED's, halogen bulb, lasers, (or the like).

5. A Glovelight, aka Superlight-Superspot as in claim 4, wherein the switches are of a round type to be easily manipulated by the thumb, toggle type switches, push button switches, or any other type of switch, or any number, or variation of switches best suited for the application.

6. A Glovelight, aka Superlight-Superspot as in claim 5, wherein the casing/housing is designed to ride on the back of the hand, wrist, fore arm, or upper arm, via any form of attachment to the hand, fore arm, upper arm, or wrist (ie. a fingerless glove, a fingered glove, a stretchable band, or the like) up to, and including the casing/housing itself used as the form of attachment to the hand, fingers, any part of the hand, wrist, fore arm, or upper arm.

7. A Glovelight, aka Superlight-Superspot as in claim 6, wherein the light beam projected is to be projected in a forward direction, left direction, right direction, or upward direction, or any variation, or combination of directions.

8. A Glovelight, aka Superlight-Superspot as in claim 7, wherein the wearer/operator may use the Glovelight, aka Superlight-Superspot for any application including any atmosphere (ie. underwater, space, or any variation, or combination of atmospheres).

9. A Glovelight, aka Superlight-Superspot as in claim 8, wherein the light beam is projected from the back of the hand, top of the hand, side of the hand (inside or outside), proximity of the hand, wrist, fore arm, or upper arm, in any type of glove, stretchable band, housing, suit, uniform, or combination of the like, or part of any suit, uniform of any type.

10. A Glovelight, aka Superlight-Superspot as in claim 9, wherein the beam projected is used as a portable light source for viewing, or being viewed in any application where a portable light source is necessary, or desired.

11. A Glovelight, aka Superlight-Superspot as in claim 10, wherein it rides on the back of the hand, wrist, fore arm, or upper arm, as to allow for hands-free operation that may also contain a compass, compartment, or the like in any combination on either hand, wrist, fore arm, or upper arm to be worn with a Glovelight, aka Superlight-Superspot or without as desired or necessary.
